(19) United States
(12) Patent Application Publication
(10) Pub. No.: US 2026/0220428 A1
(43) Pub. Date: Jul. 30, 2026

(54) SYNTHETIC DATA GENERATION VIA DATA RETRIEVAL AND AUTOMATED ACCURACY EVALUATION

(71) Applicant: Salesforce, Inc., San Francisco, CA (US)

(72) Inventors: Onkar Thorat, Palo Alto, CA (US); Jason Wu, Palo Alto, CA (US)

(21) Appl. No.: 19/041,189

(22) Filed: Jan. 30, 2025

(51) Int. Cl. G06N 3/045; G06N 3/0895

(52) U.S. Cl. CPC G06N 3/045; G06N 3/0895

(57) ABSTRACT

A system may generate synthetic data via an iterative procedure that improves diversity and accuracy of the synthetic data by evaluating performance metrics of respective portions of the generated synthetic data prior to generating subsequent portions of the synthetic data. The system may receive an input indicating seed data and a task description and, based on the seed data and the task description, retrieve data from a data source. The system may generate first examples from the retrieved data, evaluate performance of the seed data based on the generated first examples, and weight the seed data accordingly. Using the weighted seed data and the first examples, the system may retrieve new data from the data source and perform another iteration of example generation and evaluation. The system may continue to perform iterations of example generation and evaluation to generate an amount of data requested as indicated by the input.

### FIELD OF TECHNOLOGY

The present disclosure relates generally to database systems and data processing, and more specifically to synthetic data generation via data retrieval and automated accuracy evaluation.

### BACKGROUND

A cloud platform (i.e., a computing platform for cloud computing) may be employed by multiple users to store, manage, and process data using a shared network of remote servers. Users may develop applications on the cloud platform to handle the storage, management, and processing of data. In some cases, the cloud platform may utilize a multi-tenant database system. Users may access the cloud platform using various user devices (e.g., desktop computers, laptops, smartphones, tablets, or other computing systems, etc.).

In one example, the cloud platform may support customer relationship management (CRM) solutions. This may include support for sales, service, marketing, community, analytics, applications, and the Internet of Things. A user may utilize the cloud platform to help manage contacts of the user. For example, managing contacts of the user may include analyzing data, storing and preparing communications, and tracking opportunities and sales.

Some systems may generate synthetic data from seed data and a task description using a large language model (LLM). However, in some cases, the synthetic data may lack diversity, accuracy, or both.

### BRIEF DESCRIPTION OF THE DRAWINGS

FIGS. 1 and 2 illustrate examples of systems that support synthetic data generation via data retrieval and automated accuracy evaluation in accordance with aspects of the present disclosure.

FIG. 3 shows an example of a process flow that supports synthetic data generation via data retrieval and automated accuracy evaluation in accordance with aspects of the present disclosure.

FIG. 4 shows a block diagram of an apparatus that supports synthetic data generation via data retrieval and automated accuracy evaluation in accordance with aspects of the present disclosure.

FIG. 5 shows a block diagram of a synthetic data generation manager that supports synthetic data generation via data retrieval and automated accuracy evaluation in accordance with aspects of the present disclosure.

FIG. 6 shows a diagram of a system including a device that supports synthetic data generation via data retrieval and automated accuracy evaluation in accordance with aspects of the present disclosure.

FIGS. 7 and 8 show flowcharts illustrating methods that support synthetic data generation via data retrieval and automated accuracy evaluation in accordance with aspects of the present disclosure.

### DETAILED DESCRIPTION

Some systems may use large language models (LLMs) to generate synthetic data. For example, a system may input seed data and a task description into an LLM, and the LLM may output synthetic data based on the input. Synthetic data may refer to artificial data generated from a relatively small amount of actual data—or “seed data” as referred to herein—and may, if generated correctly, have similar characteristics to the seed data. For example, the LLM may generate a large amount of synthetic data from the relatively small amount of seed data, and the synthetic data may have similar statistical properties to and a same format as the seed data. In some cases, the synthetic data can be used for other artificial intelligence (AI) or machine learning (ML) models, such as for model training or testing. For example, model training and testing may involve large amounts of data that are unavailable to a user. However, synthetic data generated using LLMs may lack diversity, and some synthetic data generation techniques may not support accurate evaluation and feedback. For example, LLMs may, after generating some quantity of data, generate repeated data that is identical to either the seed data or previously generated synthetic data. Accordingly, the synthetic data lacks diversity as multiple copies of the same data are present in the generated synthetic dataset. Additionally, users may lack techniques of evaluating generated synthetic data for accuracy with respect to the provided seed data.

Techniques described herein support improved generation of synthetic data. For example, techniques described herein may implement data generation, evaluation, and feedback components that support improved diversity and accuracy of synthetic data. A system may receive multiple inputs including at least seed data, a task description, an LLM to be used to generate the synthetic data, and an amount of synthetic data to be generated (e.g., a quantity of data points). The system may retrieve data from an unstructured data source, a structured data source, a customer knowledge base, or the like that is similar to the task description and use the retrieved data to generate a first subset of synthetic data via the LLM. After generating the first subset of synthetic data, the system may evaluate performance metrics of the seed data based on the first subset of synthetic data and using a transformer-based model. For example, the system may determine whether, when compared to the first subset of synthetic data, the seed data has similar statistical properties and whether the first subset of synthetic data is reflective of each data point or example included in the seed data. The system may weight the seed data according to evaluating the performance. For example, the system may weight data points within the seed data that were not reflected within the first subset of synthetic data. Subsequently, the system may use the weighted data points, the first subset of synthetic data, and the task description to retrieve new data and use the new data to generate another subset of synthetic data via the LLM. The system may repeat the data retrieval, evaluation, and weighting until an amount of synthetic data is generated that satisfies the requested amount of synthetic data indicated in the input.

By implementing a feedback mechanism that evaluates the quality of the synthetic data throughout synthetic data generation, the synthetic data generation system described herein may support improved generation of synthetic data. For example, by evaluating performance metrics of the seed data relative to generated synthetic data portions and weighting the seed data according to the performance metrics, the synthetic data generation system may generate synthetic data that has improved diversity (e.g., compared to synthetic data generated by a system that does not implement the feedback mechanism).

Aspects of the disclosure are initially described in the context of an environment supporting an on-demand database service. Aspects of the disclosure are also described in the context of a synthetic data generation system and a process flow. Aspects of the disclosure are further illustrated by and described with reference to apparatus diagrams, system diagrams, and flowcharts that relate to synthetic data generation via data retrieval and automated accuracy evaluation.

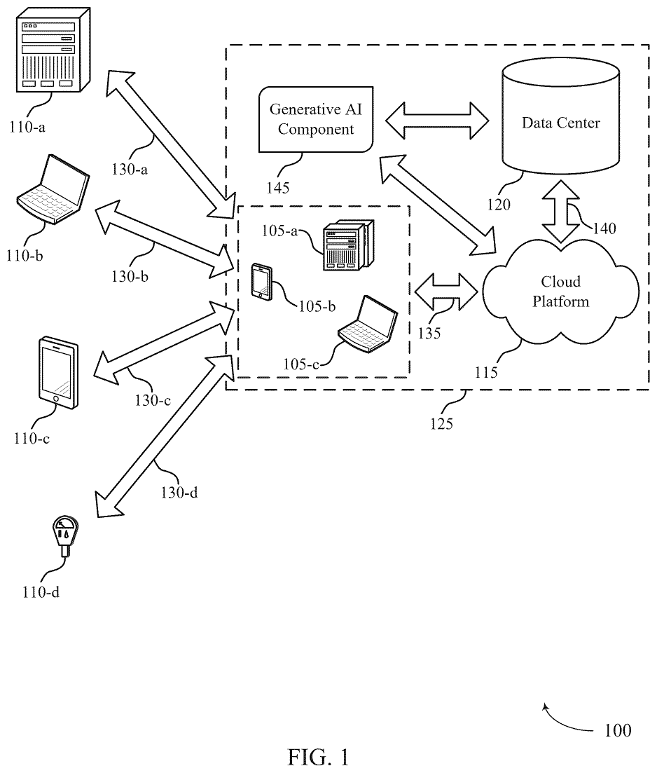

FIG. 1 illustrates an example of a system 100 for cloud computing that supports synthetic data generation via data retrieval and automated accuracy evaluation in accordance with various aspects of the present disclosure. The system 100 includes cloud clients 105, contacts 110, cloud platform 115, and data center 120. Cloud platform 115 may be an example of a public or private cloud network. A cloud client 105 may access cloud platform 115 over network connection 135. The network may implement transfer control protocol and internet protocol (TCP/IP), such as the Internet, or may implement other network protocols. A cloud client 105 may be an example of a user device, such as a server (e.g., cloud client 105-a), a smartphone (e.g., cloud client 105-b), or a laptop (e.g., cloud client 105-c). In other examples, a cloud client 105 may be a desktop computer, a tablet, a sensor, or another computing device or system capable of generating, analyzing, transmitting, or receiving communications. In some examples, a cloud client 105 may be operated by a user that is part of a business, an enterprise, a non-profit, a startup, or any other organization type.

A cloud client 105 may interact with multiple contacts 110. The interactions 130 may include communications, opportunities, purchases, sales, or any other interaction between a cloud client 105 and a contact 110. Data may be associated with the interactions 130. A cloud client 105 may access cloud platform 115 to store, manage, and process the data associated with the interactions 130. In some cases, the cloud client 105 may have an associated security or permission level. A cloud client 105 may have access to certain applications, data, and database information within cloud platform 115 based on the associated security or permission level and may not have access to others.

Contacts 110 may interact with the cloud client 105 in person or via phone, email, web, text messages, mail, or any other appropriate form of interaction (e.g., interactions 130-a, 130-b, 130-c, and 130-d). The interaction 130 may be a business-to-business (B2B) interaction or a business-to-consumer (B2C) interaction. A contact 110 may also be referred to as a customer, a potential customer, a lead, a client, or some other suitable terminology. In some cases, the contact 110 may be an example of a user device, such as a server (e.g., contact 110-a), a laptop (e.g., contact 110-b), a smartphone (e.g., contact 110-c), or a sensor (e.g., contact 110-d). In other cases, the contact 110 may be another computing system. In some cases, the contact 110 may be operated by a user or group of users. The user or group of users may be associated with a business, a manufacturer, or any other appropriate organization.

Cloud platform 115 may offer an on-demand database service to the cloud client 105. In some cases, cloud platform 115 may be an example of a multi-tenant database system. In this case, cloud platform 115 may serve multiple cloud clients 105 with a single instance of software. However, other types of systems may be implemented, including—but not limited to—client-server systems, mobile device systems, and mobile network systems. In some cases, cloud platform 115 may support CRM solutions. This may include support for sales, service, marketing, community, analytics, applications, and the Internet of Things. Cloud platform 115 may receive data associated with contact interactions 130 from the cloud client 105 over network connection 135, and may store and analyze the data. In some cases, cloud platform 115 may receive data directly from an interaction 130 between a contact 110 and the cloud client 105. In some cases, the cloud client 105 may develop applications to run on cloud platform 115. Cloud platform 115 may be implemented using remote servers. In some cases, the remote servers may be located at one or more data centers 120.

Data center 120 may include multiple servers. The multiple servers may be used for data storage, management, and processing. Data center 120 may receive data from cloud platform 115 via connection 140, or directly from the cloud client 105 or an interaction 130 between a contact 110 and the cloud client 105. Data center 120 may utilize multiple redundancies for security purposes. In some cases, the data stored at data center 120 may be backed up by copies of the data at a different data center (not pictured).

Subsystem 125 may include cloud clients 105, cloud platform 115, and data center 120. In some cases, data processing may occur at any of the components of subsystem 125, or at a combination of these components. In some cases, servers may perform the data processing. The servers may be a cloud client 105 or located at data center 120.

The system 100 may be an example of a multi-tenant system. For example, the system 100 may store data and provide applications, solutions, or any other functionality for multiple tenants concurrently. A tenant may be an example of a group of users (e.g., an organization) associated with a same tenant identifier (ID) who share access, privileges, or both for the system 100. The system 100 may effectively separate data and processes for a first tenant from data and processes for other tenants using a system architecture, logic, or both that support secure multi-tenancy. In some examples, the system 100 may include or be an example of a multi-tenant database system. A multi-tenant database system may store data for different tenants in a single database or a single set of databases. For example, the multi-tenant database system may store data for multiple tenants within a single table (e.g., in different rows) of a database. To support multi-tenant security, the multi-tenant database system may prohibit (e.g., restrict) a first tenant from accessing, viewing, or interacting in any way with data or rows associated with a different tenant. As such, tenant data for the first tenant may be isolated (e.g., logically isolated) from tenant data for a second tenant, and the tenant data for the first tenant may be invisible (or otherwise transparent) to the second tenant. The multi-tenant database system may additionally use encryption techniques to further protect tenant-specific data from unauthorized access (e.g., by another tenant).

Additionally, or alternatively, the multi-tenant system may support multi-tenancy for software applications and infrastructure. In some cases, the multi-tenant system may maintain a single instance of a software application and architecture supporting the software application in order to serve multiple different tenants (e.g., organizations, customers). For example, multiple tenants may share the same software application, the same underlying architecture, the same resources (e.g., compute resources, memory resources), the same database, the same servers or cloud-based resources, or any combination thereof. For example, the system 100 may run a single instance of software on a processing device (e.g., a server, server cluster, virtual machine) to serve multiple tenants. Such a multi-tenant system may provide for efficient integrations (e.g., using application programming interfaces (APIs)) by applying the integrations to the same software application and underlying architectures supporting multiple tenants. In some cases, processing resources, memory resources, or both may be shared by multiple tenants.

As described herein, the system 100 may support any configuration for providing multi-tenant functionality. For example, the system 100 may organize resources (e.g., processing resources, memory resources) to support tenant isolation (e.g., tenant-specific resources), tenant isolation within a shared resource (e.g., within a single instance of a resource), tenant-specific resources in a resource group, tenant-specific resource groups corresponding to a same subscription, tenant-specific subscriptions, or any combination thereof. The system 100 may support scaling of tenants within the multi-tenant system, for example, using scale triggers, automatic scaling procedures, scaling requests, or any combination thereof. In some cases, the system 100 may implement one or more scaling rules to enable relatively fair sharing of resources across tenants. For example, a tenant may have a threshold quantity of processing resources, memory resources, or both to use, which in some cases may be tied to a subscription by the tenant.

In some examples, the system 100 may include a generative artificial intelligence (AI) component 145. The generative AI component 145 may be an example or a component of a LLM, such as a generative AI model. In some examples, the generative AI component 145 may additionally, or alternatively, be referred to as any of an AI, a generative AI (GAI), a GAI model, an LLM, a machine learning model, or any similar terminology. The generative AI component 145 may be a model that is trained on a corpus of input data, which may include text, images, video, audio, structured data, or any combination thereof. Such data may represent general-purpose data, domain-specific data, or any combination thereof. Further, the generative AI component 145 may be supplemented with additional training on data associated with a role, function, or generation outcome to further specialize the generative AI component 145 and increase the accuracy and relevance of information generated with the generative AI component 145.

In some examples, the cloud platform 115 may receive a query from a cloud client 105 that may include a request to produce a response (e.g., text, images, video, audio, or other information) to the query using the generative AI component 145. The cloud platform 115 may input a prompt to the generative AI component 145 that includes, or otherwise indicates, the query (or information included therein). The generative AI component 145 may generate an output (e.g., text, images, video, audio, or other information) that is responsive to the prompt. In some examples, the cloud platform 115 may modify or supplement one or more aspects of the query to increase the quality of the response. In some examples, such modification or supplementation may be referred to as grounding.

The system 100 may support any configuration for the use of generative AI models. In FIG. 1, the generative AI component 145 is depicted as being located external to the subsystem 125. However, the generative AI component 145 may be hosted on the cloud platform 115, elsewhere within the subsystem 125, or outside the subsystem 125 (e.g., a publicly-hosted platform). Additionally, or alternatively, multiple generative AI components 145 may be employed to perform one or more of the actions described as being performed by a single generative AI component 145. Further, in some examples, the generative AI component 145 may communicate with one or more other elements, such as a contact 110, the data center 120, one or more other elements, or any combination thereof, to receive additional information (e.g., that may be indicated in the query or the prompt) that is to be considered for performing generative processes.

In various implementations, the models and/or modules described herein (e.g., including, but not limited to, the generative AI component 145) may be classification, predictive, generative, conversational, or another form of AI technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally, or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology's output with the set of documents or knowledge base.

To further guide and train output of the AI technology, one or more input prompts may be provided to the AI technology for the purpose of eliciting particular responses. In various implementations, the input prompts may correspond to the particular field or task to which the AI technology is trained. Additionally, or alternatively, the AI technology may be implemented along with one or more additional AI technologies. For example, a first AI model may produce a first output, which is used as input for a second AI model to produce a second output. These AI technologies may be used in succession of one another, in parallel with another, or a combination of both. Furthermore, the AI technologies may be merged in a variety of implementations, for example, by bagging, boosting, stacking, etc. the AI technologies.

In some examples, the subsystem 125 may utilize generative AI component 145 to generate synthetic data. For example, the subsystem 125 may generate, via the generative AI component 145, synthetic data that is to be used for model training (e.g., for a different AI model) based on seed data and a task description. Put another way, the subsystem 125 may generate synthetic data using the generative AI component 145 (e.g., via an LLM) and then use that synthetic data to train a smaller AI or ML model.

In some cases, systems may use LLMs to generate synthetic data, but the generated synthetic data may have a low level of diversity. As used herein, “diversity” may refer to variation between data points within a set of synthetic data. Synthetic data generated by an LLM may, in some cases, include repetitions of some data points (also referred to herein as “examples” or “samples”), particularly in cases where relatively large amounts of synthetic data are generated (e.g., upwards of 10,000 data points). For example, the LLM, after generating some quantity of data points, may begin to generate repetitions of those data points. Because the generated synthetic data includes repetitions of some data points, the synthetic data may have a reduced level of diversity (e.g., compared to a case where all of the data points are different). A model that is trained using synthetic data having a reduced level of diversity may be associated with reduced performance compared to a model trained using more diverse data.

Additionally, some systems may lack evaluation and feedback mechanisms that identify whether the synthetic data is aligned with seed data and a task description. For example, LLMs may output hallucinations or synthetic data that is inaccurate, nonsensical, or unrelated to the seed data and task description. Generating the synthetic data without evaluating the generated data and implementing feedback mechanisms may lead to the generated synthetic data including inaccuracies or lacking alignment with the seed data and task description.

As described herein, the subsystem 125 may implement one or more techniques to improve diversity and accuracy of synthetic data with respect to the seed data and task description. For example, the subsystem 125 may implement a feedback mechanism that involves evaluation of subsets of synthetic data generated during iterations of synthetic data generation. That is, the subsystem 125 may evaluate and provide feedback for an initial subset of synthetic data and use the evaluation and feedback to generate a subsequent subset of synthetic data. The evaluation and feedback may involve determining whether the subset of synthetic data has characteristics of the seed data, such as with respect to distribution and similarity. The subsystem 125 may weight the seed data and use weighted seed data to generate a next subset of synthetic data, where the weighted seed data improves a probability that seed data not reflected in a recent subset of synthetic data is reflected in the next subset of synthetic data. By implementing a feedback mechanism that evaluates the performance of the LLM throughout synthetic data generation, the subsystem 125 may support improved generation of synthetic data. For example, by evaluating performance metrics of the seed data relative to generated synthetic data portions and weighting the seed data according to the performance metrics, the subsystem 125 may generate synthetic data that has improved diversity (e.g., compared to synthetic data generated by a system that does not implement the feedback mechanism).

It should be appreciated by a person skilled in the art that one or more aspects of the disclosure may be implemented in a system 100 to additionally, or alternatively, solve other problems than those described above. Furthermore, aspects of the disclosure may provide technical improvements to “conventional” systems or processes as described herein. However, the description and appended drawings only include example technical improvements resulting from implementing aspects of the disclosure, and accordingly do not represent all of the technical improvements provided within the scope of the claims.

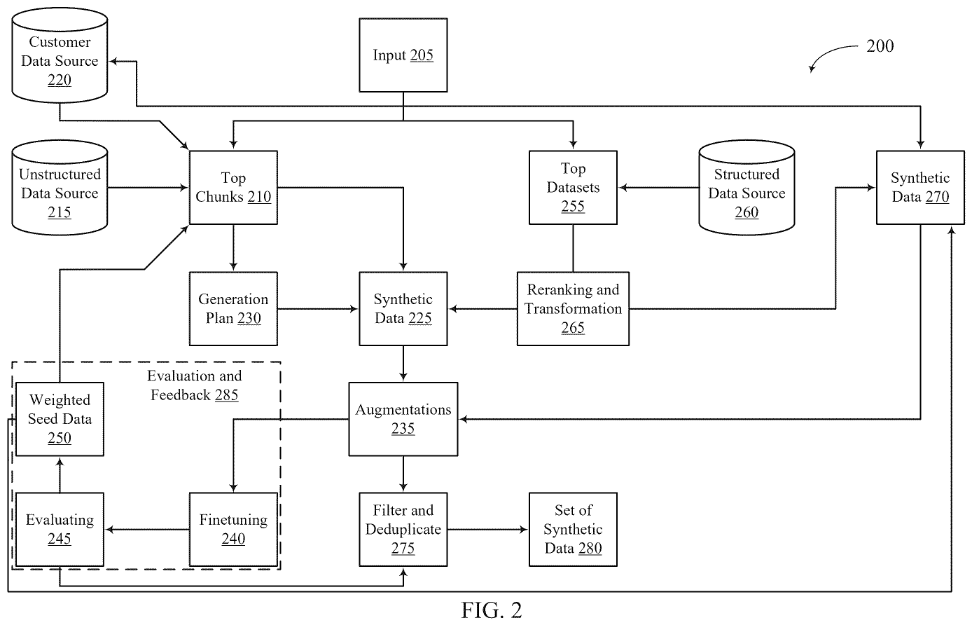

FIG. 2 shows an example of a system 200 that supports synthetic data generation via data retrieval and automated accuracy evaluation in accordance with aspects of the present disclosure. The system 200 may implement or be implemented by one or more devices or systems as described with reference to FIG. 1. In some examples, the system 200 may include an unstructured data source 215, a customer data source 220, and a structured data source 260, which may be examples of or components of the data center 120 as described with reference to FIG. 2. Additionally, or alternatively, the system 200 may generate synthetic data and evaluate performance of data generation using one or more AI models, which may be examples of the generative AI component 145 as described with reference to FIG. 1.

The system 200 may receive an input 205. The input 205 may include a task description, a quantity of data points (e.g., requested for generation, such as an amount of data in the set of synthetic data 280), seed data, and a data generation model (e.g., to be used to generate the synthetic data). The task description may include details regarding what is to be generated by the indicated data generation model. As an example, the task may be to generate a call summary from a call transcript. An example of a corresponding task description may be “Generate data where there is an input chat transcript between people and call center agents, and the output should be the summarized knowledge from transcripts after they have ended. These transcripts mainly belong to service domain.” In another example, the task may be to categorize text input. An example of a corresponding task description may be “I want to generate data for topic/intent classification which will be used in interactive systems. The model to train will take in textual input and predict the topic for that input. The main domains involved here for interactive systems shall be service and sales related belonging to single turn chats, multi turn chats, emails, and voicemails.” In such examples, the task description may also indicate the categories. The quantity of data points may refer to how much data the indicated data generation model is to generate. In the example of the call summary, the input 205 may indicate that 10,000 synthetic summaries of call transcripts are to be generated. The seed data may be an initial set of data provided as an example of the requested output. In the call summary example, the seed data may include a set of 100 summaries (e.g., generated by a human or some other tool).

Additionally, the input 205 may include selection of one or more generation options, including selection of whether to use unstructured data, structured datasets, and/or a customer knowledge base and a few-shot prompting type. For example, the input 205 may indicate to use the unstructured data source 215 or, put another way, to use retrieval chunks. As used herein, data retrieved from an unstructured data source may be referred to as chunks, portions, parts, or the like. Additionally, or alternatively, the input 205 may indicate to use the structured data source 260 or, put another way, to use datasets (e.g., Hugging Face Datasets). In some examples, the input 205 may indicate to use the structured data source 260 for augmentation (e.g., augmentations 235). The input 205 may, in some examples, indicate a customer data source 220. The customer data source 220 (e.g., customer knowledge base) may include data of or associated with the customer that is requesting generation of the synthetic data.

The input 205 may also indicate a few-shot prompting type. The few-shot prompting type may refer to use of two or more data points by the indicated data generation model to generate the synthetic data. A few-shot prompting type may refer to fixed, randomly-sampled, or adaptive few shot prompting. For example, fixed few-shot prompting may refer to using a fixed quantity of data points (e.g., 25 or fewer data points). Randomly-sampled few shot prompting may refer to using a quantity of randomly sampled data points, where the quantity is less than the total set of available data points (e.g., use 10 randomly sampled data points from seed data including more than 10 data points). Adaptive few-shot prompting may refer to using dynamically selected data points that are determined to be most relevant to input data. Selection of the data points may be based on a weighting of the respective data points, which may be described in greater detail elsewhere herein.

The system 200 may generate synthetic data according to the input 205. For example, the system 200 may retrieve data from the unstructured data source 215, the structured data source 260, the customer data source 220, or any combination thereof based on the input 205. The system 200 may perform multiple iterations of retrieval, generation, and evaluation and feedback to generate the set of synthetic data 280. For example, the system 200 may perform a first iteration, a second iteration that is based on the first iteration, and so on, where in each iteration, the system 200 may generate subsets of the set of synthetic data 280.

In examples in which the input 205 indicates to use the unstructured data source 215, the system 200 may retrieve top chunks 210. For example, in the first iteration, the system 200 may retrieve a quantity of data portions or chunks based on the seed data and the task description included in the input 205. The system 200 may retrieve unstructured retrieved data portions (e.g., chunks or documents) from the unstructured data source 215, tokenize the portions, and generate vector embeddings for each of the portions. The system 200 may compare the task description (e.g., an encoded version of the task description or a vector embedding of the task description) with the generated vector embeddings of the portions of retrieved data. Based on the comparison, the system 200 may select top or most similar documents (e.g., top chunks 210), such as according to a selection algorithm, a threshold similarity level, a threshold quantity of portions to retrieve, or the like.

Using the top chunks 210, the system 200 may generate synthetic data 225 (e.g., a first subset of synthetic data). For example, the system 200 may use the data generation model indicated in the input 205 (e.g., an LLM or a generative AI model, such as OpenAI—GPT4o, GPT4o-mini, etc.) to generate one or more data points (e.g., examples) from each of the chunks in the top chunks 210. That is, using each chunk, the system 200 may generate n data points (e.g., n =3 data points). Generating the data points may include transforming the unstructured top chunks 210 into a structured data form having format(s) and field(s) similar to the seed data provided in the input 205. The system 200 may generate the synthetic data based on few shot examples and using the few shot prompting type indicated in the input 205.

The system 200 may repeat (e.g., within the first iteration) retrieval of the top chunks 210 and generation of data points from those top chunks to generate a subset of data points. For example, in each iteration of synthetic data generation, the system 200 may generate a subset of the data points of the quantity of data points requested by the input 205. As an example, the system 200 may generate 10% of data points of the quantity of data points requested by the input 205 in each iteration (e.g., perform 10 iterations). To generate the 10% of data points during the first iteration, the system 200 may repeat the retrieval of the top chunks 210 from the unstructured data source 215 and generation of the synthetic data 225 until the 10% of data points are generated.

In some examples, the system 200 may use long context generation to generate the synthetic data 225. For example, the system 200 may generate one or more data points of the synthetic data 225 based on a generation plan 230. The generation plan 230 may be used when a data point included in the seed data exceeds a threshold size. The generation plan 230 may break up the generation for a corresponding synthetic data point into two or more parts. For example, the system 200 may generate a data point using the generation plan 230 by generating respective parts of the data point that are combined to generate the data point. In the example of a call transcript, the system 200 may portion an exemplary call transcript of the seed data into parts such as an introduction, various topics of the call, and a call wrap-up. Then, the system 200 may generate a corresponding synthetic call transcript by individually generating the parts of the call including the introduction, each of the topics, and the call wrap-up.

The system 200 may perform augmentations 235 to the synthetic data 225 (e.g., the first subset of synthetic data). For example, the system 200 may perform the augmentations 235 based on a presence of categorical fields in the task description of the input 205. Augmenting the synthetic data 225 may include adding to the generated data points to fill in the categorical fields.

The system 200 may perform evaluation and feedback 285 of the synthetic data 225 (e.g., the first subset of synthetic data, optionally including the augmentations 235). In some examples, the system 200 may perform the evaluation and feedback 285 based on the few shot prompting type being adaptive few shot prompting. Alternatively, in examples in which the few shot prompting type is random or fixed few shot prompting, the synthetic data generation system may proceed to filter and deduplicate 275 the synthetic data 225 (e.g., without evaluation and feedback 285).

The evaluation and feedback 285 may include finetuning 240 an evaluation model. The evaluation model may be a transformer-based model that is smaller compared to the data generation model used to generate the synthetic data 225. Finetuning 240 may include training the evaluation model using the synthetic data 225. For example, the system 200 may input the synthetic data 225 (e.g., the first subset of data points generated in the first iteration) to the evaluation model as training data.

Additionally, the evaluation and feedback 285 may include evaluating 245 the seed data. For example, the system 200 may input the seed data to the evaluation model that is trained via the synthetic data 225. The evaluation model may output one or more performance metrics of the seed data based on a comparison of the seed data to the synthetic data 225. For example, the performance metrics may include a perplexity (e.g., PPL), a ROUGE (e.g., Recall-Oriented Understudy for Gisting Evaluation), or the like. The perplexity may be the exponentiated average negative log-likelihood of a sequence calculated with exponent base e. The perplexity may indicate whether the distribution of the seed data and the synthetic data 225 are aligned. For example, the evaluation model may output a perplexity for each data point of the synthetic data 225, where the respective perplexities indicate whether data points of the synthetic data are reflected in the distribution of the synthetic data 225 used to train the evaluation model. The ROUGE may indicate similarity between the seed data and the synthetic data 225. For example, ROUGE may compare the input seed data to the synthetic data 225 used for model training and indicate a similarity between the data.

The system 200 may generate weighted seed data 250 to be used in subsequent iterations of synthetic data generation based on the evaluation and feedback 285. For example, system 200 may weight the seed data according to the one or more performance metrics. That is, the system 200 may weight data points within the seed data that are indicated as being absent from a distribution of the synthetic data 225 (e.g., according to the perplexity), dissimilar to the synthetic data 225 (e.g., according to the ROUGE), or both. Increasing a weight of data points of the seed data that are not reflected in (e.g., on the basis of distribution and/or similarity) the synthetic data 225 may increase a probability that, in a subsequent iteration of synthetic data generation, the weighted data points are selected for adaptive few shot prompting and used to generate synthetic data. That is, by weighting the data in accordance with the one or more performance metrics, the system 200 may improve the synthetic data 225 (e.g., by improving the synthetic data 225 similarity and distribution with respect to the seed data).

Using the weighted seed data 250, the data points generated in the first iteration (e.g., the first subset of synthetic data), and the task description, the system 200 may perform a second iteration, including retrieving top chunks 210 from the unstructured data source 215, generating additional data points (e.g., a second subset of synthetic data), and performing evaluation and feedback 285. The top chunks 210 retrieved during the second iteration may be different than any of the top chunks 210 retrieved during the first iteration, as the top chunks 210 from the first iteration may be discarded after use. The system 200 may perform the retrieval and generation in a similar manner as described with respect to the first iteration, but rather than the retrieval and generation being based on the seed data and task description, the retrieval and generation may be based on the weighted seed data 250, the data points generated in the first iteration (e.g., the first subset of synthetic data), and the task description. That is, the system 200 may generate synthetic data 225 using few shot prompting that is based on the weighted seed data 250. For example, the system 200 (e.g., in the example of adaptive few shot prompting) may select “shots” or data points from the weighted seed data 250 rather than unweighted seed data, as done in the first iteration. By selecting the data points to use for generation of synthetic data 225 from the weighted seed data 250, the system 200 may improve the distribution and similarity of the synthetic data 225 with respect to the seed data.

The system 200 may perform the evaluation and feedback 285 for the synthetic data 225 generated during the second iteration. For example, the system 200 may input the additional data points (e.g., the second subset of synthetic data) as training data to the evaluation model and evaluate the performance of the seed data relative to the data points generated both in the first iteration and in the second iteration. Based on the evaluation, the system 200 may again weight the seed data.

The system 200 may continue to perform iterations of retrieval, generation, and evaluation and feedback to generate the set of synthetic data 280, where each iteration uses weighted seed data and subset(s) of synthetic data from prior iteration(s). After generating the amount of synthetic data requested by the input 205, the system 200 may filter and deduplicate 275 the data. For example, the system 200 may remove data points having one or more fields absent, incorrect fields, or both from the synthetic data. Additionally, or alternatively, the system 200 may, for categorical fields, remove data points that include labels absent from the seed data. After filtering and deduplicating the data, the system 200 may output the set of synthetic data 280 to the customer that provided the input 205.

In examples in which the input 205 indicates to use the customer data source 220, the structured data source 260, or both, the iterations of data retrieval described herein may involve or implement retrieval of data from data sources indicated in the input 205. For example, if the input 205 indicates to use the structured data source 260, the system 200 may retrieve top datasets 255 from the structured data source 260 and perform reranking and transformation 265 for the retrieved top datasets 255. If the input 205 indicates to use both the unstructured data source 215 and the structured data source 260, the system 200 may use both the reranked and transformed data from the structured data source and the top chunks 210 from the unstructured data source 215 to generate synthetic data 225. Alternatively, if the input 205 indicates to use the structured data source 260 (e.g., and not the unstructured data source 215), the system 200 may generate the synthetic data 270. Data retrieved from the customer data source 220 and the structured data source 260 may be used to generate synthetic data that is subject to evaluation and feedback 285, similarly to the application of evaluation and feedback 285 to the synthetic data 225 generated from the unstructured data source 215 as described herein.

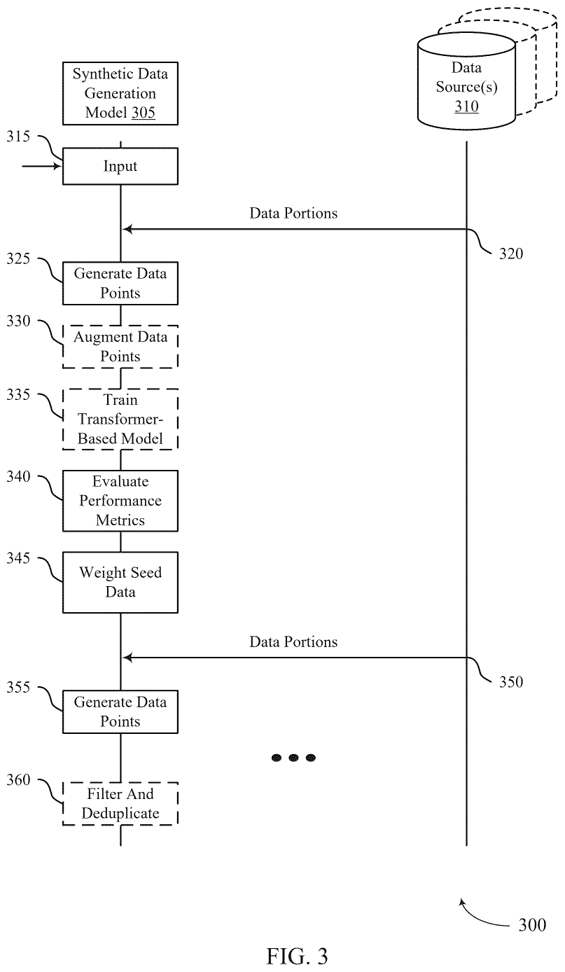

FIG. 3 shows an example of a process flow 300 that supports synthetic data generation via data retrieval and automated accuracy evaluation in accordance with aspects of the present disclosure. The process flow 300 may be implemented by a synthetic data generation model 305 and data source(s) 310. The synthetic data generation model 305 and the data source(s) 310 may be examples of corresponding devices or systems as described with reference to FIGS. 1 and 2. For example, the synthetic data generation model 305 may be an example of or include the LLM and the transformer-based model as described with reference to FIG. 2. Additionally, or alternatively, data source(s) 310 may be examples of or include the data center 120 as described with reference to FIG. 1 or the unstructured data source 215, the customer data source 220, and the structured data source 260 as described with reference to FIG. 2.

Alternative examples of the following may be implemented, where some operations are performed in a different order than described or are not performed at all. In some cases, operations may include additional features not mentioned below, or further operations may be added. Although the synthetic data generation model 305 and the data source(s) 310 are shown performing the operations of the process flow 300, some aspects of some operations may also be performed by one or more other components.

At 315, the synthetic data generation model 305 may receive an input. For example, the synthetic data generation model 305 may receive an input indicating seed data, a task description, an LLM to be used for the synthetic data generation, and an amount of synthetic data to be generated. The input may be an example of the input 205 as described with reference to FIG. 2.

At 320, the synthetic data generation model 305 may obtain data portions from the data source(s) 310. For example, the synthetic data generation model 305 may retrieve a first quantity of data portions from an unstructured data source based at least in part on the seed data and the task description. In some examples, the data portions from the unstructured data source may be referred to as “chunks.” The synthetic data generation model 305 may retrieve the first quantity of data portions having highest similarity levels to the task description. The unstructured data source may be an example of the unstructured data source 215 as described with reference to FIG. 2. For example, the unstructured data source may include publicly-available data, data associated with a customer that provided the input at 315, or both.

In some examples, the synthetic data generation model 305 may retrieve the data portions from one or more other data sources in addition to or alternatively from the unstructured data source. For example, the synthetic data generation model 305 may retrieve a quantity of datasets from a structured data source based on the seed data and the task description, where generating the first subset of synthetic data is further (e.g., or alternatively) based on the quantity of datasets from the structured data source. The synthetic data generation model 305 may retrieve the data portions in accordance with the input received at 315. For example, the input may indicate data sources from which data is to be retrieved for the synthetic data generation.

At 325, the synthetic data generation model 305 may generate data points. For example, the synthetic data generation model 305 may generate, using the LLM (e.g., indicated in the input at 315), a first subset of synthetic data based on the first quantity of data portions and the seed data. That is, the synthetic data generation model 305 may translate the portions or “chunks” of data retrieved from the data source(s) 310 into a subset of data points (e.g., of a set of data points requested via the input at 315).

In some examples, the synthetic data generation model 305 may generate the first subset of synthetic data, the second subset of synthetic data, or both as multiple tokens, where synthetic data of the first subset of synthetic data, the second subset of synthetic data (e.g., generated at 355), or both includes a combination of tokens of the multiple tokens. That is, each data point included in the synthetic data (e.g., or the subsets of synthetic data) may correspond to or be generated as one or more tokens. In some aspects, a data point of the synthetic data may include more than one token (e.g., a combination of tokens) in examples in which a corresponding data point of the seed data that the data point of the synthetic data is based on is longer than a threshold length.

The synthetic data generation model 305 may support long context generation. For example, the synthetic data generation model 305 may generate the first subset of synthetic data, the second subset of synthetic data (e.g., generated at 355), or both in accordance with a generation plan. The generation plan may be based on a data point included in the seed data exceeding a threshold size. The generation plan may include a plan for generation of data point portions or parts of two or more parts that are combined to generate a respective example of the first subset of synthetic data, the second subset of synthetic data, or both.

At 330, the synthetic data generation model 305 may augment the data points. For example, the synthetic data generation model 305 may augment the first subset of synthetic data, the second subset of synthetic data (e.g., generated at 355), or both based on a presence of one or more categorical fields in the task description. Augmenting the data points may be an example of the augmentations 235 as described with reference to FIG. 2.

At 335, the synthetic data generation model 305 may train a transformer-based model. For example, the synthetic data generation model 305 may train the transformer-based model using the first subset of synthetic data. Training the transformer-based model may be an example of the finetuning 240 as described with reference to FIG. 2.

At 340, the synthetic data generation model 305 may evaluate performance metrics. For example, the synthetic data generation model 305 may evaluate, using the transformer-based model, one or more performance metrics of the seed data based on the first subset of synthetic data. In some examples, the synthetic data generation model 305 may evaluate the one or more performance metrics based on training the transformer-based model. That is, the synthetic data generation model 305 may evaluate the one or more performance metrics after generating the metrics using the trained transformer-based model. Evaluating the one or more performance metrics may be an example of the evaluating 245 as described with reference to FIG. 2.

At 345, the synthetic data generation model 305 may weight seed data. For example, the synthetic data generation model 305 may weight respective data of the seed data based on evaluating the one or more performance metrics. In some examples, weighting the seed data may include applying a first weighting factor to a first part of the seed data (e.g., one or more data points included in the seed data) based on one or more first performance metrics of the first part being below one or more thresholds, the one or more first performance metrics generated via the transformer-based model. The weighted respective data may be an example of the weighted seed data 250 as described with reference to FIG. 2.

At 350, the synthetic data generation model 305 may obtain data portions. For example, the synthetic data generation model 305 may retrieve a second quantity of data portions from the unstructured data source based on the task description, the weighted respective data of the seed data, and the first subset of synthetic data. As noted above, the synthetic data generation model 305 may retrieve the data portions from one or more other data sources in addition to or alternatively from the unstructured data source. That is, the synthetic data generation model 305 may retrieve the data portions at 320 and at 350 in accordance with the input received at 315. In some examples, the synthetic data generation model 305 may retrieve the second quantity of data portions having highest similarity levels to the task description, to the weighted data of the seed data, and to the first subset of synthetic data.

At 355, the synthetic data generation model 305 may generate data points. For example, the synthetic data generation model 305 may generate, using the LLM, a second subset of synthetic data based on the second quantity of data portions. The synthetic data generation model 305 may perform the operations at 330 through 345 for the second subset of synthetic data. Subsequently, the synthetic data generation model 305 may retrieve a third quantity of data portions and generate a third subset of synthetic data. That is, the synthetic data generation model 305 may iteratively perform the operations of the process flow 300 to generate data points (e.g., synthetic data) that satisfy a quantity of data points requested by the input at 315. In each iteration, the synthetic data generation model 305 may retrieve data portions based on data points generated in previous iteration(s).

At 360, the synthetic data generation model 305 may filter and deduplicate. For example, the synthetic data generation model 305 may filter and deduplicate the first subset of synthetic data and the second subset of synthetic data, where a total set of synthetic data is obtained based on the filtering and deduplicating. Filtering and deduplicating may be an example of the filter and deduplicate 275 as described in the example of FIG. 2. The synthetic data generation model 305 may filter and deduplicate the synthetic data as a total set of synthetic data. A total set of synthetic data may include the first subset of synthetic data, the second subset of synthetic data, and one or more additional subsets of synthetic data. Put another way, the total set of synthetic data may include the amount of synthetic data to be generated in accordance with the input.

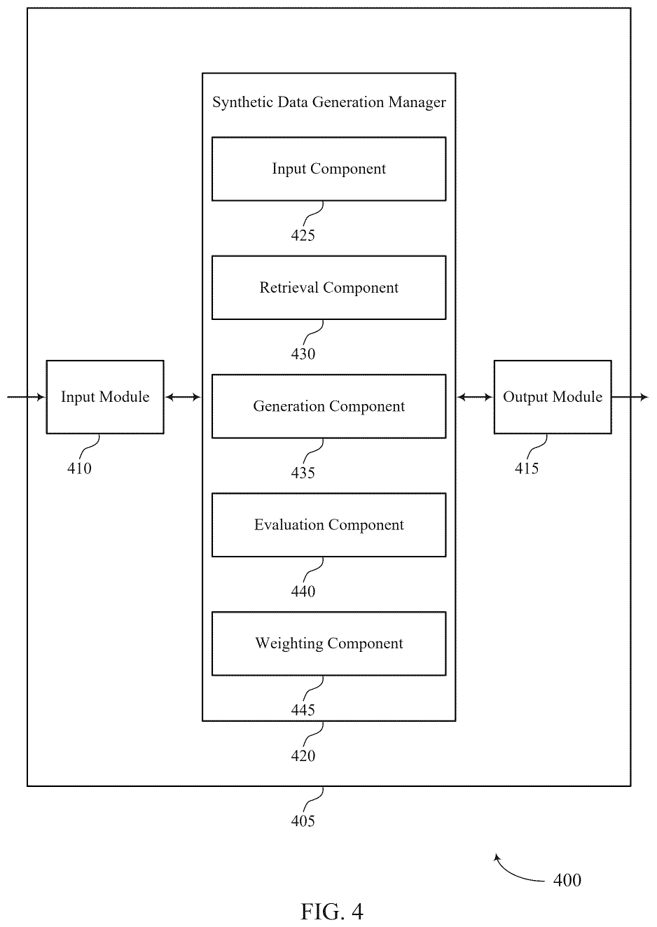

FIG. 4 shows a block diagram 400 of a device 405 that supports synthetic data generation via data retrieval and automated accuracy evaluation in accordance with aspects of the present disclosure. The device 405 may include an input module 410, an output module 415, and a synthetic data generation manager 420. The device 405, or one or more components of the device 405 (e.g., the input module 410, the output module 415, the synthetic data generation manager 420), may include at least one processor, which may be coupled with at least one memory, to support the described techniques. Each of these components may be in communication with one another (e.g., via one or more buses).

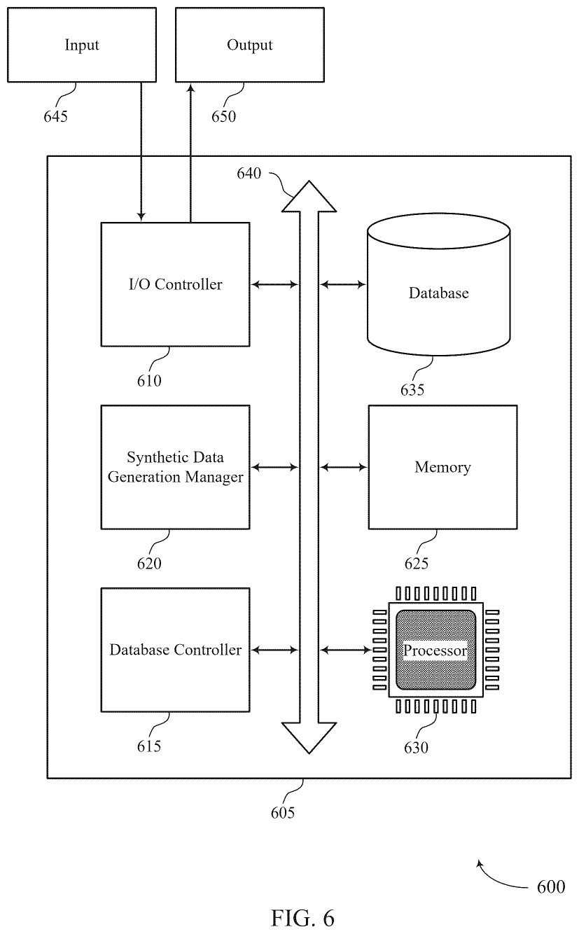

The input module 410 may manage input signals for the device 405. For example, the input module 410 may identify input signals based on an interaction with a modem, a keyboard, a mouse, a touchscreen, or a similar device. These input signals may be associated with user input or processing at other components or devices. In some cases, the input module 410 may utilize an operating system such as iOS®, ANDROID®, MS-DOS®, MS-WINDOWS®, OS/2®, UNIX®, LINUX®, or another known operating system to handle input signals. The input module 410 may send aspects of these input signals to other components of the device 405 for processing. For example, the input module 410 may transmit input signals to the synthetic data generation manager 420 to support synthetic data generation via data retrieval and automated accuracy evaluation. In some cases, the input module 410 may be a component of an input/output (I/O) controller 610 as described with reference to FIG. 6.

The output module 415 may manage output signals for the device 405. For example, the output module 415 may receive signals from other components of the device 405, such as the synthetic data generation manager 420, and may transmit these signals to other components or devices. In some examples, the output module 415 may transmit output signals for display in a user interface, for storage in a database or data store, for further processing at a server or server cluster, or for any other processes at any number of devices or systems. In some cases, the output module 415 may be a component of an I/O controller 610 as described with reference to FIG. 6.

For example, the synthetic data generation manager 420 may include an input component 425, a retrieval component 430, a generation component 435, an evaluation component 440, a weighting component 445, or any combination thereof. In some examples, the synthetic data generation manager 420, or various components thereof, may be configured to perform various operations (e.g., receiving, monitoring, transmitting) using or otherwise in cooperation with the input module 410, the output module 415, or both. For example, the synthetic data generation manager 420 may receive information from the input module 410, send information to the output module 415, or be integrated in combination with the input module 410, the output module 415, or both to receive information, transmit information, or perform various other operations as described herein.

The synthetic data generation manager 420 may support synthetic data generation in accordance with examples as disclosed herein. The input component 425 may be configured to support receiving an input indicating seed data, a task description, a LLM to be used for the synthetic data generation, and an amount of synthetic data to be generated. The retrieval component 430 may be configured to support retrieving a first quantity of data portions from an unstructured data source based on the seed data and the task description. The generation component 435 may be configured to support generating, using the LLM, a first subset of synthetic data based on the first quantity of data portions and the seed data. The evaluation component 440 may be configured to support evaluating, using a transformer-based model, one or more performance metrics of the seed data based on the first subset of synthetic data. The weighting component 445 may be configured to support weighting respective data of the seed data based on evaluating the one or more performance metrics. The retrieval component 430 may be configured to support retrieving a second quantity of data portions from the unstructured data source based on the task description, the weighted respective data of the seed data, and the first subset of synthetic data. The generation component 435 may be configured to support generating, using the LLM, a second subset of synthetic data based on the second quantity of data portions.

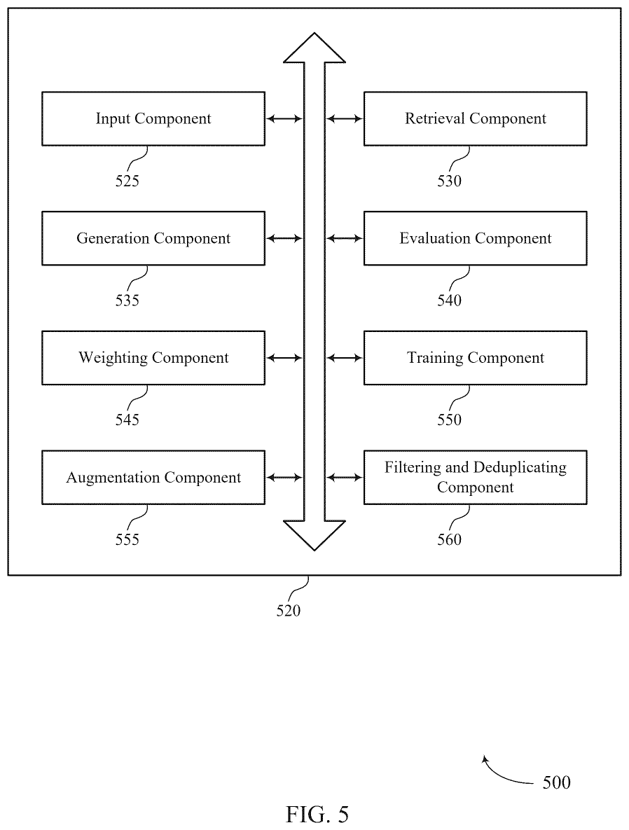

FIG. 5 shows a block diagram 500 of a synthetic data generation manager 520 that supports synthetic data generation via data retrieval and automated accuracy evaluation in accordance with aspects of the present disclosure. The synthetic data generation manager 520 may be an example of aspects of a synthetic data generation manager or a synthetic data generation manager 420, or both, as described herein. The synthetic data generation manager 520, or various components thereof, may be an example of means for performing various aspects of synthetic data generation via data retrieval and automated accuracy evaluation as described herein. For example, the synthetic data generation manager 520 may include an input component 525, a retrieval component 530, a generation component 535, an evaluation component 540, a weighting component 545, a training component 550, an augmentation component 555, a filtering and deduplicating component 560, or any combination thereof. Each of these components, or components of subcomponents thereof (e.g., one or more processors, one or more memories), may communicate, directly or indirectly, with one another (e.g., via one or more buses).

The synthetic data generation manager 520 may support synthetic data generation in accordance with examples as disclosed herein. The input component 525 may be configured to support receiving an input indicating seed data, a task description, a LLM to be used for the synthetic data generation, and an amount of synthetic data to be generated. The retrieval component 530 may be configured to support retrieving a first quantity of data portions from an unstructured data source based on the seed data and the task description. The generation component 535 may be configured to support generating, using the LLM, a first subset of synthetic data based on the first quantity of data portions and the seed data. The evaluation component 540 may be configured to support evaluating, using a transformer-based model, one or more performance metrics of the seed data based on the first subset of synthetic data. The weighting component 545 may be configured to support weighting respective data of the seed data based on evaluating the one or more performance metrics. In some examples, the retrieval component 530 may be configured to support retrieving a second quantity of data portions from the unstructured data source based on the task description, the weighted respective data of the seed data, and the first subset of synthetic data. In some examples, the generation component 535 may be configured to support generating, using the LLM, a second subset of synthetic data based on the second quantity of data portions.

In some examples, a total set of synthetic data includes the first subset of synthetic data, the second subset of synthetic data, and one or more additional subsets of synthetic data. In some examples, the total set of synthetic data includes the amount of synthetic data to be generated in accordance with the input.

In some examples, to support generating the first subset of synthetic data, the second subset of synthetic data, or both, the generation component 535 may be configured to support generating the first subset of synthetic data, the second subset of synthetic data, or both as a set of multiple tokens, where synthetic data of the first subset of synthetic data, the second subset of synthetic data, or both includes a combination of tokens of the set of multiple tokens.

In some examples, the generation component 535 may be configured to support generating the first subset of synthetic data, the second subset of synthetic data, or both in accordance with a generation plan, where the generation plan is based on an example of a set of multiple examples included in the seed data exceeding a threshold size, and where the generation plan includes a plan for generation of respective portions of two or more portions that are combined to generate respective data of the first subset of synthetic data, the second subset of synthetic data, or both.

In some examples, to support weighting the respective data of the seed data, the weighting component 545 may be configured to support applying a first weighting factor to a first part of the seed data based on one or more first performance metrics of the first part being below one or more thresholds, the one or more first performance metrics generated via the transformer-based model.

In some examples, the training component 550 may be configured to support training the transformer-based model using the first subset of synthetic data, where the one or more performance metrics of the seed data are evaluated using the trained transformer-based model.

In some examples, the augmentation component 555 may be configured to support augmenting the first subset of synthetic data, the second subset of synthetic data, or both based on a presence of one or more categorical fields in the task description.

In some examples, the retrieval component 530 may be configured to support retrieving a quantity of datasets from a structured data source based on the seed data and the task description, where generating the first subset of synthetic data is further based on the quantity of datasets from the structured data source.

In some examples, to support retrieving the first quantity of data portions, the retrieval component 530 may be configured to support retrieving the first quantity of data portions having highest similarity levels to the task description.

In some examples, to support retrieving the second quantity of data portions, the retrieval component 530 may be configured to support retrieving the second quantity of data portions having highest similarity levels to the task description, to the weighted data of the seed data, and to the first subset of synthetic data.

In some examples, the filtering and deduplicating component 560 may be configured to support filtering and deduplicating the first subset of synthetic data and the second subset of synthetic data, where a total set of synthetic data is obtained based on the filtering and deduplicating.

In some examples, the unstructured data source includes publicly-available data, data associated with a customer that provided the input, or both.

FIG. 6 shows a diagram of a system 600 including a device 605 that supports synthetic data generation via data retrieval and automated accuracy evaluation in accordance with aspects of the present disclosure. The device 605 may be an example of or include components of a device 405 as described herein. The device 605 may include components for bi-directional data communications including components for transmitting and receiving communications, such as a synthetic data generation manager 620, an I/O controller, such as an I/O controller 610, a database controller 615, at least one memory 625, at least one processor 630, and a database 635. These components may be in electronic communication or otherwise coupled (e.g., operatively, communicatively, functionally, electronically, electrically) via one or more buses (e.g., a bus 640).

The I/O controller 610 may manage input signals 645 and output signals 650 for the device 605. The I/O controller 610 may also manage peripherals not integrated into the device 605. In some cases, the I/O controller 610 may represent a physical connection or port to an external peripheral. In some cases, the I/O controller 610 may utilize an operating system such as iOS®, ANDROID®, MS-DOS®, MS-WINDOWS®, OS/2®, UNIX®, LINUX®, or another known operating system. In other cases, the I/O controller 610 may represent or interact with a modem, a keyboard, a mouse, a touchscreen, or a similar device. In some cases, the I/O controller 610 may be implemented as part of a processor 630. In some examples, a user may interact with the device 605 via the I/O controller 610 or via hardware components controlled by the I/O controller 610.

The database controller 615 may manage data storage and processing in a database 635. In some cases, a user may interact with the database controller 615. In other cases, the database controller 615 may operate automatically without user interaction. The database 635 may be an example of a single database, a distributed database, multiple distributed databases, a data store, a data lake, or an emergency backup database.

Memory 625 may include random-access memory (RAM) and read-only memory (ROM). The memory 625 may store computer-readable, computer-executable software including instructions that, when executed, cause at least one processor 630 to perform various functions described herein. In some cases, the memory 625 may contain, among other things, a basic I/O system (BIOS) which may control basic hardware or software operation such as the interaction with peripheral components or devices. The memory 625 may be an example of a single memory or multiple memories. For example, the device 605 may include one or more memories 625.

The processor 630 may include an intelligent hardware device (e.g., a general-purpose processor, a digital signal processor (DSP), a central processing unit (CPU), a microcontroller, an application-specific integrated circuit (ASIC), a field-programmable gate array (FPGA), a programmable logic device, a discrete gate or transistor logic component, a discrete hardware component, or any combination thereof). In some cases, the processor 630 may be configured to operate a memory array using a memory controller. In other cases, a memory controller may be integrated into the processor 630. The processor 630 may be configured to execute computer-readable instructions stored in at least one memory 625 to perform various functions (e.g., functions or tasks supporting synthetic data generation via data retrieval and automated accuracy evaluation). The processor 630 may be an example of a single processor or multiple processors. For example, the device 605 may include one or more processors 630.

The synthetic data generation manager 620 may support synthetic data generation in accordance with examples as disclosed herein. For example, the synthetic data generation manager 620 may be configured to support receiving an input indicating seed data, a task description, a LLM to be used for the synthetic data generation, and an amount of synthetic data to be generated. The synthetic data generation manager 620 may be configured to support retrieving a first quantity of data portions from an unstructured data source based on the seed data and the task description. The synthetic data generation manager 620 may be configured to support generating, using the LLM, a first subset of synthetic data based on the first quantity of data portions and the seed data. The synthetic data generation manager 620 may be configured to support evaluating, using a transformer-based model, one or more performance metrics of the seed data based on the first subset of synthetic data. The synthetic data generation manager 620 may be configured to support weighting respective data of the seed data based on evaluating the one or more performance metrics. The synthetic data generation manager 620 may be configured to support retrieving a second quantity of data portions from the unstructured data source based on the task description, the weighted respective data of the seed data, and the first subset of synthetic data. The synthetic data generation manager 620 may be configured to support generating, using the LLM, a second subset of synthetic data based on the second quantity of data portions.

By including or configuring the synthetic data generation manager 620 in accordance with examples as described herein, the device 605 may support techniques for improved generation of synthetic data, including generation of synthetic data with improved diversity based on application of evaluation and feedback during synthetic data generation.

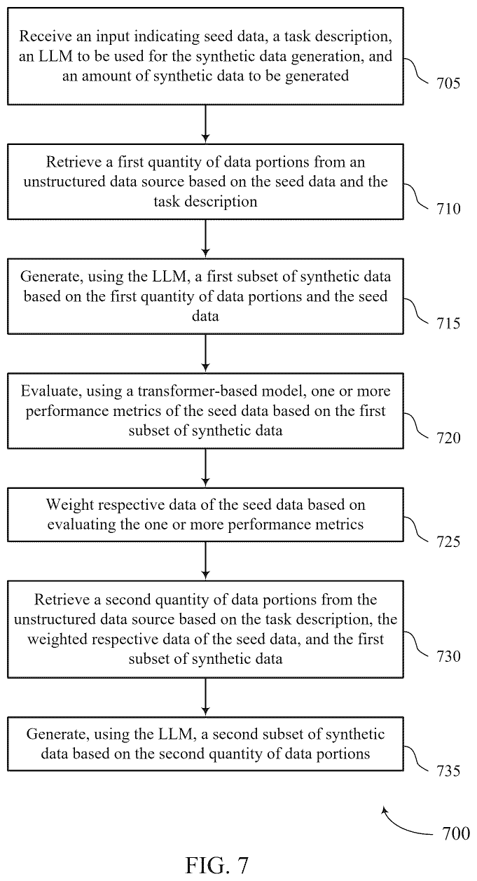

FIG. 7 shows a flowchart illustrating a method 700 that supports synthetic data generation via data retrieval and automated accuracy evaluation in accordance with aspects of the present disclosure. The operations of the method 700 may be implemented by a Salesforce Device or its components as described herein. For example, the operations of the method 700 may be performed by a Salesforce Device as described with reference to FIGS. 1 through 6. In some examples, a Salesforce Device may execute a set of instructions to control the functional elements of the Salesforce Device to perform the described functions. Additionally, or alternatively, the Salesforce Device may perform aspects of the described functions using special-purpose hardware.

At 705, the method may include receiving an input indicating seed data, a task description, a LLM to be used for the synthetic data generation, and an amount of synthetic data to be generated. The operations of 705 may be performed in accordance with examples as disclosed herein. In some examples, aspects of the operations of 705 may be performed by an input component 525 as described with reference to FIG. 5.

At 710, the method may include retrieving a first quantity of data portions from an unstructured data source based on the seed data and the task description. The operations of 710 may be performed in accordance with examples as disclosed herein. In some examples, aspects of the operations of 710 may be performed by a retrieval component 530 as described with reference to FIG. 5.

At 715, the method may include generating, using the LLM, a first subset of synthetic data based on the first quantity of data portions and the seed data. The operations of 715 may be performed in accordance with examples as disclosed herein. In some examples, aspects of the operations of 715 may be performed by a generation component 535 as described with reference to FIG. 5.

At 720, the method may include evaluating, using a transformer-based model, one or more performance metrics of the seed data based on the first subset of synthetic data. The operations of 720 may be performed in accordance with examples as disclosed herein. In some examples, aspects of the operations of 720 may be performed by an evaluation component 540 as described with reference to FIG. 5.

At 725, the method may include weighting respective data of the seed data based on evaluating the one or more performance metrics. The operations of 725 may be performed in accordance with examples as disclosed herein. In some examples, aspects of the operations of 725 may be performed by a weighting component 545 as described with reference to FIG. 5.

At 730, the method may include retrieving a second quantity of data portions from the unstructured data source based on the task description, the weighted respective data of the seed data, and the first subset of synthetic data. The operations of 730 may be performed in accordance with examples as disclosed herein. In some examples, aspects of the operations of 730 may be performed by a retrieval component 530 as described with reference to FIG. 5.

At 735, the method may include generating, using the LLM, a second subset of synthetic data based on the second quantity of data portions. The operations of 735 may be performed in accordance with examples as disclosed herein. In some examples, aspects of the operations of 735 may be performed by a generation component 535 as described with reference to FIG. 5.

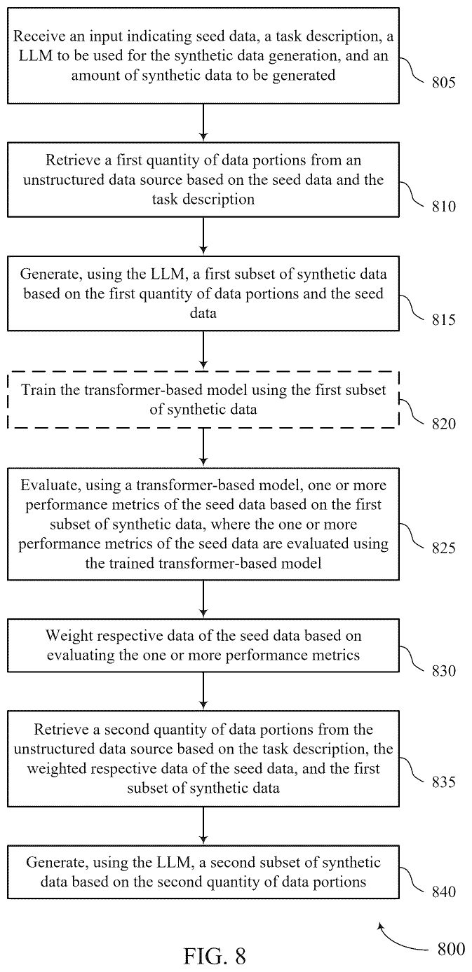

FIG. 8 shows a flowchart illustrating a method 800 that supports synthetic data generation via data retrieval and automated accuracy evaluation in accordance with aspects of the present disclosure. The operations of the method 800 may be implemented by a Salesforce Device or its components as described herein. For example, the operations of the method 800 may be performed by a Salesforce Device as described with reference to FIGS. 1 through 6. In some examples, a Salesforce Device may execute a set of instructions to control the functional elements of the Salesforce Device to perform the described functions. Additionally, or alternatively, the Salesforce Device may perform aspects of the described functions using special-purpose hardware.

At 805, the method may include receiving an input indicating seed data, a task description, a LLM to be used for the synthetic data generation, and an amount of synthetic data to be generated. The operations of 805 may be performed in accordance with examples as disclosed herein. In some examples, aspects of the operations of 805 may be performed by an input component 525 as described with reference to FIG. 5.

At 810, the method may include retrieving a first quantity of data portions from an unstructured data source based on the seed data and the task description. The operations of 810 may be performed in accordance with examples as disclosed herein. In some examples, aspects of the operations of 810 may be performed by a retrieval component 530 as described with reference to FIG. 5.

At 815, the method may include generating, using the LLM, a first subset of synthetic data based on the first quantity of data portions and the seed data. The operations of 815 may be performed in accordance with examples as disclosed herein. In some examples, aspects of the operations of 815 may be performed by a generation component 535 as described with reference to FIG. 5.

At 820, the method may include training the transformer-based model using the first subset of synthetic data. The operations of 820 may be performed in accordance with examples as disclosed herein. In some examples, aspects of the operations of 820 may be performed by a training component 550 as described with reference to FIG. 5.

At 825, the method may include evaluating, using a transformer-based model, one or more performance metrics of the seed data based on the first subset of synthetic data, where the one or more performance metrics of the seed data are evaluated using the trained transformer-based model. The operations of 825 may be performed in accordance with examples as disclosed herein. In some examples, aspects of the operations of 825 may be performed by an evaluation component 540 as described with reference to FIG. 5.

At 830, the method may include weighting respective data of the seed data based on evaluating the one or more performance metrics. The operations of 830 may be performed in accordance with examples as disclosed herein. In some examples, aspects of the operations of 830 may be performed by a weighting component 545 as described with reference to FIG. 5.

At 835, the method may include retrieving a second quantity of data portions from the unstructured data source based on the task description, the weighted respective data of the seed data, and the first subset of synthetic data. The operations of 835 may be performed in accordance with examples as disclosed herein. In some examples, aspects of the operations of 835 may be performed by a retrieval component 530 as described with reference to FIG. 5.

At 840, the method may include generating, using the LLM, a second subset of synthetic data based on the second quantity of data portions. The operations of 840 may be performed in accordance with examples as disclosed herein. In some examples, aspects of the operations of 840 may be performed by a generation component 535 as described with reference to FIG. 5.

A method for synthetic data generation by an apparatus is described. The method may include receiving an input indicating seed data, a task description, a LLM to be used for the synthetic data generation, and an amount of synthetic data to be generated, retrieving a first quantity of data portions from an unstructured data source based on the seed data and the task description, generating, using the LLM, a first subset of synthetic data based on the first quantity of data portions and the seed data, evaluating, using a transformer-based model, one or more performance metrics of the seed data based on the first subset of synthetic data, weighting respective data of the seed data based on evaluating the one or more performance metrics, retrieving a second quantity of data portions from the unstructured data source based on the task description, the weighted respective data of the seed data, and the first subset of synthetic data, and generating, using the LLM, a second subset of synthetic data based on the second quantity of data portions.

An apparatus for synthetic data generation is described. The apparatus may include one or more memories storing processor executable code, and one or more processors coupled with the one or more memories. The one or more processors may individually or collectively be operable to execute the code to cause the apparatus to receive an input indicating seed data, a task description, a LLM to be used for the synthetic data generation, and an amount of synthetic data to be generated, retrieve a first quantity of data portions from an unstructured data source based on the seed data and the task description, generate, using the LLM, a first subset of synthetic data based on the first quantity of data portions and the seed data, evaluate, using a transformer-based model, one or more performance metrics of the seed data based on the first subset of synthetic data, weight respective data of the seed data based on evaluating the one or more performance metrics, retrieve a second quantity of data portions from the unstructured data source based on the task description, the weighted respective data of the seed data, and the first subset of synthetic data, and generate, using the LLM, a second subset of synthetic data based on the second quantity of data portions.

Another apparatus for synthetic data generation is described. The apparatus may include means for receiving an input indicating seed data, a task description, a LLM to be used for the synthetic data generation, and an amount of synthetic data to be generated, means for retrieving a first quantity of data portions from an unstructured data source based on the seed data and the task description, means for generating, using the LLM, a first subset of synthetic data based on the first quantity of data portions and the seed data, means for evaluating, using a transformer-based model, one or more performance metrics of the seed data based on the first subset of synthetic data, means for weighting respective data of the seed data based on evaluating the one or more performance metrics, means for retrieving a second quantity of data portions from the unstructured data source based on the task description, the weighted respective data of the seed data, and the first subset of synthetic data, and means for generating, using the LLM, a second subset of synthetic data based on the second quantity of data portions.

A non-transitory computer-readable medium storing code for synthetic data generation is described. The code may include instructions executable by one or more processors to receive an input indicating seed data, a task description, a LLM to be used for the synthetic data generation, and an amount of synthetic data to be generated, retrieve a first quantity of data portions from an unstructured data source based on the seed data and the task description, generate, using the LLM, a first subset of synthetic data based on the first quantity of data portions and the seed data, evaluate, using a transformer-based model, one or more performance metrics of the seed data based on the first subset of synthetic data, weight respective data of the seed data based on evaluating the one or more performance metrics, retrieve a second quantity of data portions from the unstructured data source based on the task description, the weighted respective data of the seed data, and the first subset of synthetic data, and generate, using the LLM, a second subset of synthetic data based on the second quantity of data portions.

In some examples of the method, apparatus, and non-transitory computer-readable medium described herein, a total set of synthetic data includes the first subset of synthetic data, the second subset of synthetic data, and one or more additional subsets of synthetic data and the total set of synthetic data includes the amount of synthetic data to be generated in accordance with the input.

In some examples of the method, apparatus, and non-transitory computer-readable medium described herein, generating the first subset of synthetic data, the second subset of synthetic data, or both may include operations, features, means, or instructions for generating the first subset of synthetic data, the second subset of synthetic data, or both as a set of multiple tokens, where synthetic data of the first subset of synthetic data, the second subset of synthetic data, or both includes a combination of tokens of the set of multiple tokens.

Some examples of the method, apparatus, and non-transitory computer-readable medium described herein may further include operations, features, means, or instructions for generating the first subset of synthetic data, the second subset of synthetic data, or both in accordance with a generation plan, where the generation plan may be based on an example of a set of multiple examples included in the seed data exceeding a threshold size, and where the generation plan includes a plan for generation of respective portions of two or more portions that may be combined to generate respective data of the first subset of synthetic data, the second subset of synthetic data, or both.

In some examples of the method, apparatus, and non-transitory computer-readable medium described herein, weighting the respective data of the seed data may include operations, features, means, or instructions for applying a first weighting factor to a first part of the seed data based on one or more first performance metrics of the first part being below one or more thresholds, the one or more first performance metrics generated via the transformer-based model.

Some examples of the method, apparatus, and non-transitory computer-readable medium described herein may further include operations, features, means, or instructions for training the transformer-based model using the first subset of synthetic data, where the one or more performance metrics of the seed data may be evaluated using the trained transformer-based model.

Some examples of the method, apparatus, and non-transitory computer-readable medium described herein may further include operations, features, means, or instructions for augmenting the first subset of synthetic data, the second subset of synthetic data, or both based on a presence of one or more categorical fields in the task description.

Some examples of the method, apparatus, and non-transitory computer-readable medium described herein may further include operations, features, means, or instructions for retrieving a quantity of datasets from a structured data source based on the seed data and the task description, where generating the first subset of synthetic data may be further based on the quantity of datasets from the structured data source.

In some examples of the method, apparatus, and non-transitory computer-readable medium described herein, retrieving the first quantity of data portions may include operations, features, means, or instructions for retrieving the first quantity of data portions having highest similarity levels to the task description.

In some examples of the method, apparatus, and non-transitory computer-readable medium described herein, retrieving the second quantity of data portions may include operations, features, means, or instructions for retrieving the second quantity of data portions having highest similarity levels to the task description, to the weighted data of the seed data, and to the first subset of synthetic data.

Some examples of the method, apparatus, and non-transitory computer-readable medium described herein may further include operations, features, means, or instructions for filtering and deduplicating the first subset of synthetic data and the second subset of synthetic data, where a total set of synthetic data may be obtained based on the filtering and deduplicating.

In some examples of the method, apparatus, and non-transitory computer-readable medium described herein, the unstructured data source includes publicly-available data, data associated with a customer that provided the input, or both.

The following provides an overview of aspects of the present disclosure:

Aspect 1: A method for synthetic data generation, comprising: receiving an input indicating seed data, a task description, a LLM to be used for the synthetic data generation, and an amount of synthetic data to be generated; retrieving a first quantity of data portions from an unstructured data source based at least in part on the seed data and the task description; generating, using the LLM, a first subset of synthetic data based at least in part on the first quantity of data portions and the seed data; evaluating, using a transformer-based model, one or more performance metrics of the seed data based at least in part on the first subset of synthetic data; weighting respective data of the seed data based at least in part on evaluating the one or more performance metrics; retrieving a second quantity of data portions from the unstructured data source based at least in part on the task description, the weighted respective data of the seed data, and the first subset of synthetic data; and generating, using the LLM, a second subset of synthetic data based at least in part on the second quantity of data portions.

Aspect 2: The method of aspect 1, wherein a total set of synthetic data comprises the first subset of synthetic data, the second subset of synthetic data, and one or more additional subsets of synthetic data, and the total set of synthetic data includes the amount of synthetic data to be generated in accordance with the input.

Aspect 3: The method of any of aspects 1 through 2, wherein generating the first subset of synthetic data, the second subset of synthetic data, or both comprises: generating the first subset of synthetic data, the second subset of synthetic data, or both as a plurality of tokens, wherein synthetic data of the first subset of synthetic data, the second subset of synthetic data, or both comprises a combination of tokens of the plurality of tokens.

Aspect 4: The method of any of aspects 1 through 3, further comprising: generating the first subset of synthetic data, the second subset of synthetic data, or both in accordance with a generation plan, wherein the generation plan is based at least in part on an example of a plurality of examples included in the seed data exceeding a threshold size, and wherein the generation plan comprises a plan for generation of respective portions of two or more portions that are combined to generate respective data of the first subset of synthetic data, the second subset of synthetic data, or both.

Aspect 5: The method of any of aspects 1 through 4, wherein weighting the respective data of the seed data comprises: applying a first weighting factor to a first part of the seed data based at least in part on one or more first performance metrics of the first part being below one or more thresholds, the one or more first performance metrics generated via the transformer-based model.

Aspect 6: The method of any of aspects 1 through 5, further comprising: training the transformer-based model using the first subset of synthetic data, wherein the one or more performance metrics of the seed data are evaluated using the trained transformer-based model.

Aspect 7: The method of any of aspects 1 through 6, further comprising: augmenting the first subset of synthetic data, the second subset of synthetic data, or both based at least in part on a presence of one or more categorical fields in the task description.

Aspect 8: The method of any of aspects 1 through 7, further comprising: retrieving a quantity of datasets from a structured data source based at least in part on the seed data and the task description, wherein generating the first subset of synthetic data is further based at least in part on the quantity of datasets from the structured data source.

Aspect 9: The method of any of aspects 1 through 8, wherein retrieving the first quantity of data portions comprises: retrieving the first quantity of data portions having highest similarity levels to the task description.

Aspect 10: The method of any of aspects 1 through 9, wherein retrieving the second quantity of data portions comprises: retrieving the second quantity of data portions having highest similarity levels to the task description, to the weighted data of the seed data, and to the first subset of synthetic data.

Aspect 11: The method of any of aspects 1 through 10, further comprising: filtering and deduplicating the first subset of synthetic data and the second subset of synthetic data, wherein a total set of synthetic data is obtained based at least in part on the filtering and deduplicating.

Aspect 12: The method of any of aspects 1 through 11, wherein the unstructured data source comprises publicly-available data, data associated with a customer that provided the input, or both.

Aspect 13: An apparatus for synthetic data generation, comprising one or more memories storing processor-executable code, and one or more processors coupled with the one or more memories and individually or collectively operable to execute the code to cause the apparatus to perform a method of any of aspects 1 through 12.

Aspect 14: An apparatus for synthetic data generation, comprising at least one means for performing a method of any of aspects 1 through 12.

Aspect 15: A non-transitory computer-readable medium storing code for synthetic data generation, the code comprising instructions executable by one or more processors to perform a method of any of aspects 1 through 12.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, electrically erasable programmable ROM (EEPROM), compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for synthetic data generation, comprising:
receiving an input indicating seed data, a task description, a large language model (LLM) to be used for the synthetic data generation, and an amount of synthetic data to be generated;
retrieving a first quantity of data portions from an unstructured data source based at least in part on the seed data and the task description;
generating, using the LLM, a first subset of synthetic data based at least in part on the first quantity of data portions and the seed data;
evaluating, using a transformer-based model, one or more performance metrics of the seed data based at least in part on the first subset of synthetic data;
weighting respective data of the seed data based at least in part on evaluating the one or more performance metrics;
retrieving a second quantity of data portions from the unstructured data source based at least in part on the task description, the weighted respective data of the seed data, and the first subset of synthetic data; and
generating, using the LLM, a second subset of synthetic data based at least in part on the second quantity of data portions.

2. The method of claim 1, wherein:
a total set of synthetic data comprises the first subset of synthetic data, the second subset of synthetic data, and one or more additional subsets of synthetic data, and
the total set of synthetic data includes the amount of synthetic data to be generated in accordance with the input.

3. The method of claim 1, wherein generating the first subset of synthetic data, the second subset of synthetic data, or both comprises:
generating the first subset of synthetic data, the second subset of synthetic data, or both as a plurality of tokens, wherein synthetic data of the first subset of synthetic data, the second subset of synthetic data, or both comprises a combination of tokens of the plurality of tokens.

4. The method of claim 1, further comprising:
generating the first subset of synthetic data, the second subset of synthetic data, or both in accordance with a generation plan, wherein the generation plan is based at least in part on an example of a plurality of examples included in the seed data exceeding a threshold size, and wherein the generation plan comprises a plan for generation of respective portions of two or more portions that are combined to generate respective data of the first subset of synthetic data, the second subset of synthetic data, or both.

5. The method of claim 1, wherein weighting the respective data of the seed data comprises:
applying a first weighting factor to a first part of the seed data based at least in part on one or more first performance metrics of the first part being below one or more thresholds, the one or more first performance metrics generated via the transformer-based model.

6. The method of claim 1, further comprising:
training the transformer-based model using the first subset of synthetic data, wherein the one or more performance metrics of the seed data are evaluated using the trained transformer-based model.

7. The method of claim 1, further comprising:
augmenting the first subset of synthetic data, the second subset of synthetic data, or both based at least in part on a presence of one or more categorical fields in the task description.

8. The method of claim 1, further comprising:
retrieving a quantity of datasets from a structured data source based at least in part on the seed data and the task description, wherein generating the first subset of synthetic data is further based at least in part on the quantity of datasets from the structured data source.

9. The method of claim 1, wherein retrieving the first quantity of data portions comprises:
retrieving the first quantity of data portions having highest similarity levels to the task description.

10. The method of claim 1, wherein retrieving the second quantity of data portions comprises:
retrieving the second quantity of data portions having highest similarity levels to the task description, to the weighted data of the seed data, and to the first subset of synthetic data.

11. The method of claim 1, further comprising:
filtering and deduplicating the first subset of synthetic data and the second subset of synthetic data, wherein a total set of synthetic data is obtained based at least in part on the filtering and deduplicating.

12. The method of claim 1, wherein the unstructured data source comprises publicly-available data, data associated with a customer that provided the input, or both.

13. An apparatus for synthetic data generation, comprising:
one or more memories storing processor-executable code; and
one or more processors coupled with the one or more memories and individually or collectively operable to execute the code to cause the apparatus to:
receive an input indicating seed data, a task description, a large language model (LLM) to be used for the synthetic data generation, and an amount of synthetic data to be generated;
retrieve a first quantity of data portions from an unstructured data source based at least in part on the seed data and the task description;
generate, using the LLM, a first subset of synthetic data based at least in part on the first quantity of data portions and the seed data;
evaluate, using a transformer-based model, one or more performance metrics of the seed data based at least in part on the first subset of synthetic data;
weight respective data of the seed data based at least in part on evaluating the one or more performance metrics;
retrieve a second quantity of data portions from the unstructured data source based at least in part on the task description, the weighted respective data of the seed data, and the first subset of synthetic data; and
generate, using the LLM, a second subset of synthetic data based at least in part on the second quantity of data portions.

14. The apparatus of claim 13, wherein:
a total set of synthetic data comprises the first subset of synthetic data, the second subset of synthetic data, and one or more additional subsets of synthetic data, and
the total set of synthetic data includes the amount of synthetic data to be generated in accordance with the input.

15. The apparatus of claim 13, wherein, to generate the first subset of synthetic data, the second subset of synthetic data, or both, the one or more processors are individually or collectively operable to execute the code to cause the apparatus to:
generate the first subset of synthetic data, the second subset of synthetic data, or both as a plurality of tokens, wherein synthetic data of the first subset of synthetic data, the second subset of synthetic data, or both comprises a combination of tokens of the plurality of tokens.

16. The apparatus of claim 13, wherein the one or more processors are individually or collectively further operable to execute the code to cause the apparatus to:
generate the first subset of synthetic data, the second subset of synthetic data, or both in accordance with a generation plan, wherein the generation plan is based at least in part on an example of a plurality of examples included in the seed data exceeding a threshold size, and wherein the generation plan comprises a plan for generation of respective portions of two or more portions that are combined to generate respective data of the first subset of synthetic data, the second subset of synthetic data, or both.

17. A non-transitory computer-readable medium storing code for synthetic data generation, the code comprising instructions executable by one or more processors to:
receive an input indicating seed data, a task description, a large language model (LLM) to be used for the synthetic data generation, and an amount of synthetic data to be generated;
retrieve a first quantity of data portions from an unstructured data source based at least in part on the seed data and the task description;
generate, using the LLM, a first subset of synthetic data based at least in part on the first quantity of data portions and the seed data;
evaluate, using a transformer-based model, one or more performance metrics of the seed data based at least in part on the first subset of synthetic data;
weight respective data of the seed data based at least in part on evaluating the one or more performance metrics;
retrieve a second quantity of data portions from the unstructured data source based at least in part on the task description, the weighted respective data of the seed data, and the first subset of synthetic data; and
generate, using the LLM, a second subset of synthetic data based at least in part on the second quantity of data portions.

18. The non-transitory computer-readable medium of claim 17, wherein:
a total set of synthetic data comprises the first subset of synthetic data, the second subset of synthetic data, and one or more additional subsets of synthetic data, and
the total set of synthetic data includes the amount of synthetic data to be generated in accordance with the input.

19. The non-transitory computer-readable medium of claim 17, wherein the instructions to generate the first subset of synthetic data, the second subset of synthetic data, or both are executable by the one or more processors to:
generate the first subset of synthetic data, the second subset of synthetic data, or both as a plurality of tokens, wherein synthetic data of the first subset of synthetic data, the second subset of synthetic data, or both comprises a combination of tokens of the plurality of tokens.

20. The non-transitory computer-readable medium of claim 17, wherein the instructions are further executable by the one or more processors to:
generate the first subset of synthetic data, the second subset of synthetic data, or both in accordance with a generation plan, wherein the generation plan is based at least in part on an example of a plurality of examples included in the seed data exceeding a threshold size, and wherein the generation plan comprises a plan for generation of respective portions of two or more portions that are combined to generate respective data of the first subset of synthetic data, the second subset of synthetic data, or both.
